(19) United States
(12) Patent Application Publication
(10) Pub. No.: US 2009/0172760 A1
(43) Pub. Date: Jul. 2, 2009

(54) Method and Apparatus for Metadata-Based Conditioned Use of Audio-Visual Content

(75) Inventors: Brett Lindsley, Wheaton, IL (US); Matt Defano, Chicago, IL (US); Jianjun Fang, Long Grove, IL (US); Bhavan Gandhi, Vernon Hills, IL (US); Alfonso Martinez Smith, Algonquin, IL (US); Robert G. Scheffler, Peyton, CO (US)

Correspondence Address: MOTOROLA/FETF, 120 SOUTH LASALLE STREET, SUITE 1600, CHICAGO, IL, 60603-3406, US

(73) Assignee: MOTOROLA, INC., Schaumburg, IL (US)

(21) Appl. No.: 11/965,026

(22) Filed: Dec. 27, 2007

(51) Int. Cl. H04N 7/173

(52) U.S. Cl. 725/114

(57) ABSTRACT

An audio-visual content service provider processor (201) receives (101) audio-visual content from at least a first content provider (203), which audio-visual content is to be distributed to end users (205) of the audio-visual content service provider processor. That audio-visual content service provider processor then facilitates distribution (103) of the audio-visual content to the end users (pursuant, for example, to a corresponding broadcast schedule). This audio-visual content service provider processor also receives (104) metadata that comprises conditions regarding the audio-visual content.

### RELATED APPLICATION(S)

This application is related to co-pending and co-owned attorney's docket number CML06334 (7303/91204), entitled METHOD AND APPARATUS TO FACILITATE THE LOCAL RECORDING OF AUDIO-VISUAL CONTENT FOR SUBSEQUENT RE-BROADCASTING IN THE ABSENCE OF END USER REQUESTS and filed on even date herewith, which is incorporated by reference in its entirety herein.

This application is related to co-pending and co-owned attorney's docket number CML06335 (7303/91205), entitled METHOD AND APPARATUS TO FACILITATE PROVIDING ON-DEMAND ACCESS TO INTERNET MEDIA CONTENT WITH OTHER TELEVISED CONTENT and filed on even date herewith, which is incorporated by reference in its entirety herein.

This application is related to co-pending and co-owned attorney's docket number CML06336 (7303/91206), entitled METHOD AND APPARATUS FOR PROVIDING A DYNAMIC PROGRAMMING GUIDE CONTAINING FUTURE TIMES WHEN ON-DEMAND BROADCASTING REQUESTS CAN BE SATISFIED and filed on even date herewith, which is incorporated by reference in its entirety herein.

### TECHNICAL FIELD

This invention relates generally to audio-visual content-based services and more particularly to the provision of audio-visual content to service provider end users.

### BACKGROUND

Audio-visual materials of various kinds are well known in the art as are various ways of conveying such content to an end user to facilitate the consumption of the former by the latter. In many cases, an audio-visual content service provider obtains such audio-visual content from one or more content providers and arranges for the distribution of that content to one or more end users. In the case of televised audio-visual content, such an audio-visual content service provider often comprises, for example, a Community Access Television (CATV) service provider, an Internet Provider Television (IPTV) service provider, a mobile device service provider (such as a cellular telephony service provider), or the like.

In many cases this audio-visual content is distributed to the end user pursuant to a scheduled multipoint broadcast. By this approach, an audience of end users collectively all independently select a particular channel at a particular time on a particular day to receive a given predetermined and scheduled presentation of a given item of audio-visual content. In many cases such presentations are scheduled days, weeks, or even months in advance. Such an approach, of course, offers little viewing flexibility for the end user.

As a result, many end users employ recording platforms (such as video tape recorders and digital video recorders) at their homes to record scheduled transmissions to enable a later, more convenient private viewing of the scheduled presentation. Such an approach, though generally viewed as technically feasible as well as legal, nevertheless fails to address all end user needs. As one example in this regard, the recording equipment itself can be costly to the end user and/or relatively complicated to utilize. As another example in this regard, a given end user may be interested in viewing more simultaneously presented items of audio-visual content than can be accommodated by their recording equipment.

As a partial attempt to meet these inadequacies, some audio-visual content service providers provide so-called video on demand (VOD) services. By this approach, the end user can make a selection from amongst a relatively small and limited number of audio-visual content items (often relatively recent theatrical releases). Upon making such a selection at a time of convenience, the end user is then able to begin receiving the selected item. Though gaining in popularity, such VOD services nevertheless fail in significant regards to meet the needs of end users in this regard.

As noted, such offerings are usually highly limited in number. These limitations are due, in large part, to a need to carefully negotiate the availability of such content with the original content provider. These negotiations typically entail both technical and legal considerations and are quite ill-suited to any application context that might even begin to approximate a real-time or near-real time operational paradigm. As an effective result, VOD offerings remain, for the most part, relegated to particularly noteworthy, relatively aged audio-visual content where the corresponding support activity appears to be worth the effort.

### BRIEF DESCRIPTION OF THE DRAWINGS

The above needs are at least partially met through provision of the method and apparatus for metadata-based conditioned use of audio-visual content described in the following detailed description, particularly when studied in conjunction with the drawings, wherein:

FIG. 1 comprises a flow diagram as configured in accordance with various embodiments of the invention;

FIG. 2 comprises a block diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, an audio-visual content service provider processor receives audio-visual content from at least a first content provider, which audio-visual content is to be distributed to end users of the audio-visual content service provider processor. That audio-visual content service provider processor then facilitates distribution of the audio-visual content to the end users (pursuant, for example, to a corresponding broadcast schedule). This audio-visual content service provider processor also receives metadata that comprises conditions regarding the audio-visual content.

These conditions can vary somewhat with the corresponding application setting. By one approach, these conditions can comprise, for example, a life cycle rule that determines when the audio-visual content must be deleted by the audio-visual content service provider processor. As another example, these conditions can comprise a capture rule that indicates when to capture the audio-visual content. As yet another example, these conditions can comprise a visibility rule that indicates when the audio-visual content may be presented to an end user.

These teachings will accommodate the aforementioned reception of the audio-visual content by the audio-visual content service provider processor via a content delivery plane. These teachings will also accommodate receiving the aforementioned metadata via a metadata delivery plane. The content delivery plane and the metadata delivery plane can be physically and logically discrete from one another or can be physically and/or logically combined as desired.

By one approach, the aforementioned conditions can comprise usage instructions regarding, for example, usage of the audio-visual content other than with respect to an original broadcasting of the audio-visual content to the end users. Such usage might pertain, for example, to one or more re-broadcasting conditions such as, but not limited to, a number of permitted re-broadcasts, a quality of service requirement, a requirement regarding inclusion of additional audio-visual content (such as advertising and/or promotional material), a requirement indicating what audio-video content is to be made simultaneously available to the end user by the service provider, and so forth.

So configured, those skilled in the art will recognize and appreciate that these teachings provide a flexible and highly scalable mechanism for permitting a wide variety of audio-visual content to be recorded by an audio-visual content service provider processor (even in the absence of a specific request from an end user that such an action occur) and then later provided to end users via a corresponding video on demand process of choice. In particular, these teachings provide an efficient and effective way of permitting a content provider to set any of a wide variety of conditions regarding the recording, retainment, and subsequent usage of their audio-visual content to thereby provide a simple and powerful basis for permitting and ensuring that the audio-visual content service provider processor deals with such properties and materials in both a technologically and legally appropriate manner.

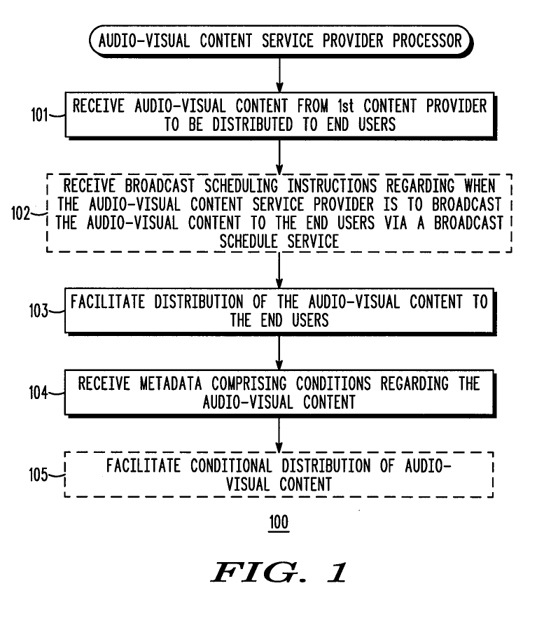

These and other benefits may become clearer upon making a thorough review and study of the following detailed description. Referring now to the drawings, and in particular to FIG. 1, an illustrative process that is compatible with many of these teachings will now be presented.

This process 100 can be carried out at an audio-visual content service provider such as, but not limited to, a Community Access Television (CATV) service provider (which can comprise, for example, a cable-based service provider or a satellite-based service provider), an Internet Protocol Television (IPTV) service provider, a mobile device service provider such as a cellular telephony service provider, and so forth. More particularly, this process 100 can be effectuated at the head end facilities of the audio-visual content service provider as versus, for example, at the facilities of the content providers or at the facilities of the end users.

As described herein, and for the sake of simplicity, this process 100 will be understood to be carried out by a processor. Those skilled in the art will recognize and appreciate that such a processor can comprise a fixed-purpose hard-wired platform or can comprise a partially or wholly programmable platform. It will also be understood that such a “processor” can comprise a single platform or can comprise a logical architecture wherein the described functionality is distributed over two or more supporting platforms. All of these architectural options are well known and understood in the art and require no further description here.

This process 100 provides for this processor receiving 101 audio-visual content from at least a first content provider, wherein this audio-visual content is received with the understanding and intent that the content be distributed to end users of the audio-visual content service provider. Such reception can be facilitated using, for example, a content delivery plane in accordance with well-understood practice in this regard. (As used herein, the expression “plane” will be understood to refer to the data delivery mechanism/technology and hence can comprise, for example, a data packet-based transport channel, a switched circuit-based transport channel, and so forth.)

In a typical (though optional) application setting, the audio-visual content service provider processor will also receive 102 broadcast scheduling instructions regarding when the audio-visual content service provider is to broadcast the audio-visual content to the end users. In some cases, the instructions are not required as the content is to be immediately relayed to the end users upon reception. In other cases, however, the audio-visual content service provider stores the received audio-visual content and holds that content for broadcasting to the end users at specified date/time as may be dictated by the sourcing content provider. By one approach, this can comprise broadcasting the audio-visual content to end users via a broadcast schedule service (as versus, for example, a video on demand service).

In any event, this process 100 then provides for facilitating the distribution 103 of the audio-visual content to the end users. This can comprise, for example, broadcasting the audio-visual content to the end users at a predetermined time as has been established and/or otherwise agreed to with the content provider. In such a case, individual end users watch (or arrange to record using an end-user tape-based or digital recorder) the broadcast as they wish. As used herein, those skilled in the art will understand that this particular distribution comprises the primary purpose of the content provider having provided the audio-visual content to the audio-visual content service provider. It will also be understood that this particular “distribution” can further comprise, if desired, re-broadcasting the audio-visual content at other times (again as per a broadcast schedule service) to thereby permit, for example, the audio-visual content to be viewed by various of the end users on a scheduled basis a number of times during a given month.

Those skilled in the art will recognize and understand that the steps described in the foregoing discussion of this process 100 can comprise prior art practice in this regard if desired. In sum and substance, these steps essentially permit one or more content providers to provision an audio-visual content service provider with audio-visual content that the audio-visual content service provider then distributes to its end users en masse via a broadcast schedule. These end users can consult a broadcast schedule to determine when to view the audio-visual content.

This process 100 also then uniquely provides for receiving 104 metadata comprising conditions regarding the audio-visual content. By one approach, this metadata can be received from the same content provider that provided the aforementioned audio-visual content. By one approach, this metadata can be received via a metadata delivery plane. Such a metadata delivery plane can be physically and/or logically discrete from the aforementioned content delivery plane or can be physically and/or logically combined or interleaved therewith as desired. By one approach, this metadata can be received by the audio-visual content service provider at essentially the same time as the audio-visual content service provider receives the corresponding audio-visual content. By another approach, this metadata can be received in advance of, or following the receipt of, the audio-visual content. It would also be possible to parse the metadata into portions that are received at various times. For example, one condition might be received prior to receipt of the audio-visual content while another condition is received contemporaneously with receipt of the audio-visual content.

The conditions themselves can vary with respect to the needs, limitations, and/or opportunities as tend to characterize a given application setting. As used herein, these conditions will be understood by those skilled in the art to comprise usage instructions regarding permitted (or prohibited) usage of the audio-visual content other than with respect to an original broadcasting of the audio-visual content to the end users (such as the broadcasting contemplated by the distribution step 103 described above). Examples in this regard might include, but are not limited to, usage instructions that specify at least one re-broadcasting condition (such as a maximum or minimum number of permitted re-broadcasts, a quality of service requirement (such as whether a re-broadcast must use, or avoid using, 5.1 surround sound, high definition content, and so forth), a requirement regarding inclusion of additional audio-visual content (such as fresh advertisement material or other promotional material, promotional trailers for other audio-visual content, so-called bonus materials such as supplemental audio commentary, blooper content, missing or extended scenes, and so forth, subtitling in various language, and so forth), or a requirement indicating what audio-visual content is to be made simultaneously available to the end user by the audio-visual content service provider, to note but a few examples in this regard.

Viewed one way, such conditions are directed to rules regarding the lifecycle of the audio-visual content (such as when the audio-visual content must be deleted from the storage facilities of the audio-visual content service provider or a capture rule indicating when the audio-visual content service provider is to capture the audio-visual content) and/or to rules regarding the permitted or prohibited visibility of the audio-visual content (such as a visibility rule indicating when and/or how the audio-visual content may be presented to an end user).

This process 100 will accommodate receiving such metadata from any authorized entity. This can include, for example, the original content source. This can also include, however, such sources as an agent for the content source, legal counsel for the content source, or even an industry organization that provides such services to subscribing content source members. Those skilled in the art will appreciate that these teachings will also accommodate considerably more complicated legal scenarios. For example, it is possible for a given item of audio-visual content to have ownership and/or control dispersed over a number of controlling entities (such as a production house, acting talent, the director, and the writers). In such a case, these teachings will ready accommodate receiving metadata from each of these entities regarding their separate and independent conditions of usage.

Using this metadata this process 100 can then provide, for example, for facilitating conditional distribution 105 of the audio-visual content that supplements the aforementioned ordinarily scheduled broadcasts of the audio-visual content. This can comprise, for example, video on demand broadcasts as may be requested from time to time by various ones of the end users. This conditional distribution will be understood to comprise distribution that is informed by and otherwise compliant with the usage instructions contained within the aforementioned conditions. As one simple example in this regard where the condition comprises a lifecycle rule, a video on demand request to view the audio-visual content subsequent to the permitted viewing window as specified by the lifecycle rule will be denied. As another simple example in this regard where the condition comprises a visibility rule regarding inclusion of a specific item of new advertising content, a video on demand request for the audio-visual content will cause the audio-visual content to be streamed to the requesting end user in combination with the specific item of new advertising content. Those skilled in the art will recognize and understand that these examples are intended to serve only in an illustrative capacity and are not intended to comprise an exhaustive listing of all possibilities in this regard.

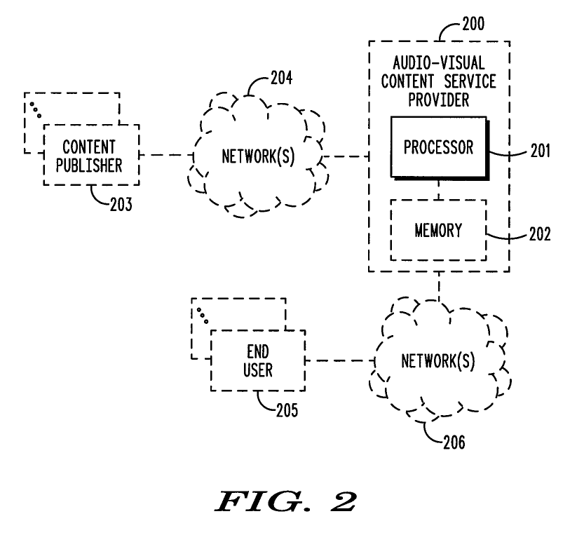

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example, an audio-visual content service provider 200 comprises, in part, a processor 201 that can operably couple to a memory 202 as desired. Such a memory can serve, for example, to store audio-visual content that has been recorded by the audio-visual content service provider pursuant to these teachings. These facilities can operably couple to one or more content publishers 203 via one or more intervening networks 204 (such as the Internet, dedicated landlines, or other wireline/wireless carriers of choice). These content publishers 203 can source the aforementioned audio-visual content and metadata and the audio-visual content service provider processor 201 can receive such information via the aforementioned network(s) 204.

The audio-visual content service provider's facilities can further operably couple to one or more end users 205 (such as a plurality of residential facilities such as homes, condominiums, apartments, and so forth) via one or more intervening networks 206. This network(s) 206 may be the same, in whole or in part, as the network(s) 204 that couple the audio-visual content service provider's facilities to the content publisher(s) 203 or may be different as appropriate to the specifics of a given application setting. By one approach, this network 206 can comprise a cable-based or a satellite-based television broadcasting distribution system as are well known in the art.

So configured, the aforementioned processor 201 can be configured and arranged, via, for example, corresponding programming as will be well understood by those skilled in the art, to carry out one or more of the aforementioned steps, actions, and functions. This can comprise, for example, receiving the described audio-visual content from the content publisher 203, facilitating distribution of that audio-visual content to the end users 205, and receiving the aforementioned metadata that comprises conditions regarding the audio-visual content including, specifically, conditions regarding usage of the audio-visual content in addition to the ordinary broadcasting of that audio-visual content.

Those skilled in the art will recognize and understand that such a facility 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

To further demonstrate the capabilities and effectiveness of these teachings, a more detailed description of a given illustrative instantiation will now be provided. Those skilled in the art will recognize and understand that the specifics of this example serve an illustrative purpose only and are not offered with any suggestion or intent that these specifics comprise an exhaustive listing of all such possibilities in this regard.

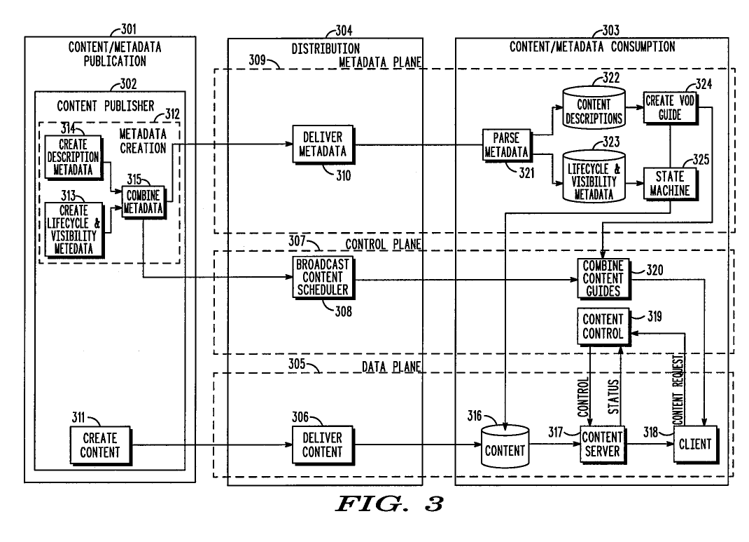

In this example, and referring now to FIG. 3, content and metadata publication 301 occurs via the facilities of a content publisher 302. Content and metadata consumption 303 occurs via the facilities (described below) of an audio-visual content service provider. The content and metadata makes its way from the former to the latter via a distribution fabric 304. This distribution fabric 304 comprises a part of each of a data plane 305 (which includes a content delivery capability 306), a control plane 307 (which includes a broadcast content scheduler 308), and a metadata plane 309 (which includes a metadata delivery capability 310) as averred to above.

The content publisher 302 can generally comprise a content creation capability 311 and a metadata creation capability 3 12. The content creation capability 311 can comprise, for example, a storage facility having the audio-visual content and a processing capability to effect such compression, protocol conversion, transcoding, encryption, content aggregation or insertion, and so forth as may be desired with respect to the transmission of the audio-visual content. The metadata creation capability 312, in turn can comprise a description metadata creation capability 313 and a conditions metadata capability which comprises, in this example, a lifecycle and visibility metadata creation capability 314. The outputs of the latter two components feed a metadata combiner 315, which combines the metadata from 313 and 314 into a single metadata object (typically represented as a single XML document). The combined metadata in 315 then provides its respective outputs to the control plane 307 and the metadata plane 309.

The audio-visual content service provider facilities, in turn, include storage facilities 316 to facilitate receiving and storing the content as sourced by the content publisher 302 and as delivered via the data plane 305. This content is then distributed via a content server 317 to one or more end users (denoted here as clients) 3 18. The content server 317 effects such distribution in response to a content control 319 (which in turn can cause the content server 317 to deliver content 316 in this example as video on demand services in response to content requests as are posed by the client(s) 3 18).

The client 318, in turn, can inform its requests based upon a content guide as provide by a content guide capability 320. The latter can serve, in this illustrative embodiment, to combine information from the broadcast content scheduler 308 (reflecting, for example, ordinarily scheduled broadcasts of audio-visual content) with information regarding video on demand candidate offerings.

The aforementioned metadata 310 is parsed by a metadata parser 321 that provides content descriptions to a corresponding memory 322 and (in this example) lifecycle and visibility metadata to another corresponding memory 323. The content description content in turn is provided to a video on demand guide creator 324 which provides video on demand information to the aforementioned content guide combiner 320.

Lastly, a state machine 325 makes use of the lifecycle and visibility metadata (i.e., the usage conditions) and uses that information to effect various useful actions. As one example, the state machine 325 can feed the video on demand guide creator 324 to thereby further inform and influence the contents of that video on demand guide. As one example in this regard, when bandwidth limitations exist, the output of the state machine 325 can permit the creator 324 to increase or decrease the immediate availability of video on demand offerings as a function of bandwidth limitations or availability. As another example, the state machine 325 can feed the aforementioned content guides combiner 320 to thereby influence its functionality. One example of its functionality would be to present VOD assets that have commercials of higher value over VOD assets with commercials of lower value. And as yet another example, the state machine 325 can influence the activities of the content storage facility 3 16. For example, given items of audio-visual content can be stored, or not stored, as a function of the output of the state machine 325.

Those skilled in the art will recognize and appreciate that these teachings provide a simple yet powerful mechanism by which an entity having a proprietary interest in an item of audio-visual content can comfortably (both technologically and legally) provide that content to a content distributor such as a cable television service provider in a way that permits the latter to make use of that content in a way that is supplemental to an ordinary broadcast of that content and yet as customized and conditional as desired by the former. These teachings are readily scalable and will accommodate handling essentially any volume of content over essentially any practical time frame. These teachings are also highly scalable with respect to offering an ability to accommodate a virtually unlimited number of unique and differentiated content provider-based/sourced conditions regarding such usage.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
at an audio-visual content service provider processor:
receiving audio-visual content from at least a first content provider to be distributed to end users of the audio-visual content service provider;
facilitating distribution of the audio-visual content to the end users;
receiving metadata comprising conditions regarding the audio-visual content.

2. The method of claim 1 wherein the conditions regarding the audio-visual content comprise at least one of:
a life cycle rule determining when the audio-visual content must be deleted;
a capture rule indicating when to capture the audio-video content;.
a visibility rule indicating when the audio-video content may be presented to an end user.

3. The method of claim 1 wherein the audio-visual content service provider comprises at least one of:
a Community Access Television (CATV) service provider;
an Internet Protocol Television (IPTV) service provider;
a mobile device service provider.

4. The method of claim 1 wherein receiving audio-visual content from at least a first content provider comprises receiving the audio-visual content from at least a first content provider via a content delivery plane.

5. The method of claim 4 wherein receiving metadata comprises receiving the metadata from the first content provider.

6. The method of claim 1 wherein receiving metadata comprising conditions regarding the audio-visual content comprises receiving the metadata via a metadata delivery plane.

7. The method of claim 1 further comprising:
receiving broadcast scheduling instructions regarding when the audio-visual content service provider is to broadcast the audio-visual content to the end users via a broadcast schedule service.

8. The method of claim 1 wherein the conditions comprise usage instructions regarding usage of the audio-visual content other than with respect to an original broadcasting of the audio-visual content to the end users.

9. The method of claim 8 wherein the usage instructions specify at least one re-broadcasting condition.

10. The method of claim 9 wherein the re-broadcasting condition comprises at least one of:
a number of permitted re-broadcasts;
a quality of service requirement;
a requirement regarding inclusion of additional audio-visual content;
a requirement indicating what audio-video content is to be made simultaneously available to the end user by the service provider.

11. An apparatus comprising:
an audio-visual content service provider processor that is configured and arranged to:
receive audio-visual content from at least a first content provider to be distributed to
end users of the audio-visual content service provider;
facilitate distribution of the audio-visual content to the end users;
receive lifecycle instructions regarding the audio-visual content;
use the lifecycle instructions to determine:
whether to record within the service provider the audio-visual content to thereby provide recorded audio-visual content;
a duration of time to retain the recorded audio-visual content before deleting the recorded audio-visual content.

12. The apparatus of claim 11 wherein the audio-visual content service provider comprises at least one of:
a Community Access Television (CATV) service provider;
an Internet Protocol Television (IPTV) service provider;
a mobile device service provider.

13. The apparatus of claim 11 wherein the processor is further configured and arranged to receive audio-visual content from at least a first content provider by receiving the audio-visual content from at least a first content provider via a content delivery plane.

14. The apparatus of claim 11 wherein the processor is further configured and arranged to receive lifecycle instructions regarding the audio-visual content by receiving the lifecycle instructions regarding the audio-visual content via a metadata delivery plane.

15. The apparatus of claim 11 wherein the processor is further configured and arranged to:
receive broadcast scheduling instructions regarding when the audio-visual content service provider is to broadcast the audio-visual content to the end users via a broadcast schedule service.

16. The apparatus of claim 11 wherein the processor is further configured and arranged to receive lifecycle instructions regarding the audio-visual content by receiving the lifecycle instructions from the first content provider.

17. The apparatus of claim 11 wherein the processor is further configured and arranged to:
receive usage instructions regarding usage of the audio-visual content other than with respect to an original broadcasting of the audio-visual content to the end users.

18. The apparatus of claim 17 wherein the usage instructions specify at least one re-broadcasting condition.

19. The apparatus of claim 18 wherein the re-broadcasting condition comprises at least one of:
a number of permitted re-broadcasts;
a quality of service requirement;
a requirement regarding inclusion of additional audio-visual content;
a requirement indicating what audio-video content is to be made simultaneously available to the end user by the service provider.
